(19) United States
(12) Patent Application Publication
(10) Pub. No.: US 2022/0060010 A1
(43) Pub. Date: Feb. 24, 2022

(54) Cable Pass Through System

(71) Applicant: Taylor James Moore, Chandler, AZ (US)

(72) Inventor: Taylor James Moore, Chandler, AZ (US)

(21) Appl. No.: 17/407,183

(22) Filed: Aug. 20, 2021

Related U.S. Application Data
(60) Provisional application No. 63/068,195, filed on Aug. 20, 2020.

(51) Int. Cl. H02G 15/013; H02G 3/22

(52) U.S. Cl. CPC H02G 15/013; H02G 3/22

(57) ABSTRACT

A cable pass through system for running one or more cables through a roof and a ceiling can comprise a cap having an inner surface and an outer surface having a thickness which can create a shell. The cap can cover and attach to a base. The seals can be attached to the base and the cap forming a seal around the cable. A gasket can be placed between the base and the roof creating a seal between the roof and the base. A backing plate can be placed on the ceiling and is removably attached to the base by one or more fasteners. The cap and the base can further comprise a recess for the one or more seals and a seal can be placed in the recess in the base wherein when pushed together the two seals create a watertight seal against the cable.

### CROSS-REFERENCE TO RELATED APPLICATIONS

This application claims benefit from currently pending U.S. Provisional Application No. 63/068,195 titled “Cable Pass Through System” and having a filing date of Aug. 20, 2020, all of which is incorporated by reference herein.

### FIELD OF THE INVENTION

The present specification relates to a cable pass through, more particularly a cable pass through system that allows for easy installation into a ceiling and roof and is watertight keeping the elements out of the vehicle.

### BACKGROUND OF THE INVENTION

Currently in the automotive and electrical industries electrical components such as light, antennas, radios, and GPS are often placed outside on the exterior of an enclosure or vehicle and are routed through an electrical enclosure or gland systems. These types of devices are controlled by the use of wires, cables, and electrical harnesses that connect to sensitive electronics often kept inside of the enclosure or vehicle while the devices are subject to the harsh elements outside like sun, water, dust, and vibration. This means that these wires and cables need to pass through a protective barrier that can keep the outside elements from the controlled inside environment. In the past this has been achieved by simply drilling a hole for the item to pass through then sealing it with silicone, or a cable gland has been used.

However, there are issues that arise when using silicone or a cable gland. For example, silicone is a rubber like material that is made for sealing two mating objects together. Most silicones that are readily available on the market are for indoor household use only, or are compounds used for replacing proper gasket materials, which means that they do not fair well in direct sunlight and weathering elements for extended periods of time. Once the silicone starts to degrade it loses its elasticity and becomes brittle and can crack and degrade thus failing to meet its primary purpose of sealing out external elements from the inside of the vehicle or enclosure.

Traditional cable glands and gromets lack the ability to hold more than one cable at a time and are sized to seal around the bulk of the wire or cabling only, which causes problems for the end user. The first issues that arises using a cable gland is that if multiple wires or cables are used in the gland there will be gaps that need to be filled using silicone. The silicone can last much longer as it is usually protected by the gland assembly. The second issue that arises is from the size of the cable glands. These glands have a range of sizes that can grip and seal against the wires and cables, which means that if a terminal or connector attached to the wire or cable is larger than the gland, the wire and cable must be installed after the installation of the cable gland and the routing of the wire or cable must be done before the final terminations can be made. Lastly, cable glands do not have a minimal profile from the surface they are mounted to which can cause interference with items mounted externally or internally around it and can be aesthetically displeasing to the user.

Therefore, there is a need for a cable routing system that allows the user to easily install and route cables and wires from an external device on the roof of an enclosure or ceiling into the vehicle or enclosure without letting the elements in.

### BRIEF SUMMARY OF THE INVENTION

In embodiments a cable pass through system for running one or more cables through a roof and a ceiling can comprise a cap having an inner surface and an outer surface having a thickness which can create a shell. The cap can cover and attach to a base with one or more fasteners. One or more seals can be attached to the base and the cap forming a seal around the cable. A gasket can be placed between the base and the roof which creates a seal between the roof and the base keeping the outside elements out. A backing plate can be placed on the ceiling and is removably attached to the base by one or more fasteners. The cap and the base can further comprise a recess for the one or more seals wherein the seal can be place in the recess in the cap and a seal can be placed in the recess in the base wherein when pushed together the two seals create a watertight seal against the cable.

The cap can further comprise a slot allowing the cable to pass through. The base can further comprise a base slot and a roof slot wherein the roof slot transitions from the base slot with a radius. The base can further comprise one or more nut locks and one or more fastener holes wherein one or more nuts can be inserted into and locked into position with the nut locks. The gasket can form a watertight seal between the base and the roof. The backing plate can comprise one or more nut slots wherein one or more fasteners fasten to the base to the backing plate with the gasket captured between the backing plate and the roof wherein the backing place compresses against the ceiling. The cap can be fastened to the base by one or more fasteners. The cap, base and backing plate can be manufactured from plastic. The base can further comprise one or more bosses wherein the bosses come into contact with the roof and keeps the gasket from over compressing.

Aspects and applications of the invention presented here are described below in the drawings and detailed description of the invention. Unless specifically noted, it is intended that the words and phrases in the specification and the claims be given their plain, ordinary, and accustomed meaning to those of ordinary skill in the applicable arts. The inventors are fully aware that they can be their own lexicographers if desired. The inventors expressly elect, as their own lexicographers, to use only the plain and ordinary meaning of terms in the specification and claims unless they clearly state otherwise and then further, expressly set forth the. Absent such clear statements of intent to apply a “special” definition, it is the inventor's intent and desire that the simple, plain, and ordinary meaning to the terms be applied to the interpretation of the specification and claims.

The inventors are also aware of the normal precepts of English grammar. Thus, if a noun, term, or phrase is intended to be further characterized, specified, or narrowed in some way, then such noun, term, or phrase will expressly include additional adjectives, descriptive terms, or other modifiers in accordance with the normal precepts of English grammar. Absent the use of such adjectives, descriptive terms, or modifiers, it is the intent that such nouns, terms, or phrases be given their plain, and ordinary English meaning to those skilled in the applicable arts as set forth above.

Further, the inventors are fully informed of the standards and application of the special provisions of 35 U.S.C. § 112 (f). Thus, the use of the words “function,” “means” or “step” in the Detailed Description or Description of the Drawings or claims is not intended to somehow indicate a desire to invoke the special provisions of 35 U.S.C. § 112 (f), to define the invention. To the contrary, if the provisions of 35 U.S.C. § 112 (f) are sought to be invoked to define the inventions, the claims will specifically and expressly state the exact phrases “means for” or “step for”, and will also recite the word “function” (i.e., will state “means for performing the function of molding a fishing lure, without also reciting in such phrases any structure, material or act in support of the function. Thus, even when the claims recite a “means for performing the function of molding a fishing lure, step for performing the function of molding a fishing lure,” if the claims also recite any structure, material or acts in support of that means or step, or that perform the recited function, then it is the clear intention of the inventors not to invoke the provisions of 35 U.S.C. § 112 (f). Moreover, even if the provisions of 35 U.S.C. § 112 (f) are invoked to define the claimed inventions, it is intended that the inventions not be limited only to the specific structure, material or acts that are described in the preferred embodiments, but in addition, include any and all structures, materials or acts that perform the claimed function as described in alternative embodiments or forms of the invention, or that are well known present or later-developed, equivalent structures, material or acts for performing the claimed function.

Additional features and advantages of the present specification will become apparent to those skilled in the art upon consideration of the following detailed description of the illustrative embodiment exemplifying the best mode of carrying out the invention as presently perceived.

### BRIEF DESCRIPTION OF THE DRAWINGS

These and other features, aspects, and advantages of the present specification will become better understood with regard to the following description, appended claims, and accompanying drawings where:

FIG. 1 is an isometric view of the cable pass through system in accordance to one, or more embodiments;

FIG. 2 is an isometric exploded view with enclosure omitted of the cable pass through system in accordance to one, or more embodiments;

FIG. 3 is an isometric view with cap omitted of the cable pass through system in accordance to one, or more embodiments;

FIG. 4 is a bottom exploded isometric view of the cable pass through system in accordance to one, or more embodiments;

FIG. 5 is a bottom isometric view of the cable pass through system in accordance to one, or more embodiments; and

FIG. 6 is a cross-sectional view of the cable pass through system in accordance to one, or more embodiments.

Elements and acts in the figures are illustrated for simplicity and have not necessarily been rendered according to any particular sequence or embodiment.

### DETAILED DESCRIPTION

In the following description, and for the purposes of explanation, numerous specific details are set forth in order to provide a thorough understanding of the various aspects of the invention. It will be understood, however, by those skilled in the relevant arts, that the present invention may be practiced without these specific details. In other instances, known structures and devices are shown or discussed more generally in order to avoid obscuring the invention. In many cases, a description of the operation is sufficient to enable one to implement the various forms of the invention, particularly when the operation is to be implemented in software. It should be noted that there are many different and alternative configurations, devices and technologies to which the disclosed inventions may be applied. The full scope of the inventions is not limited to the examples that are described below.

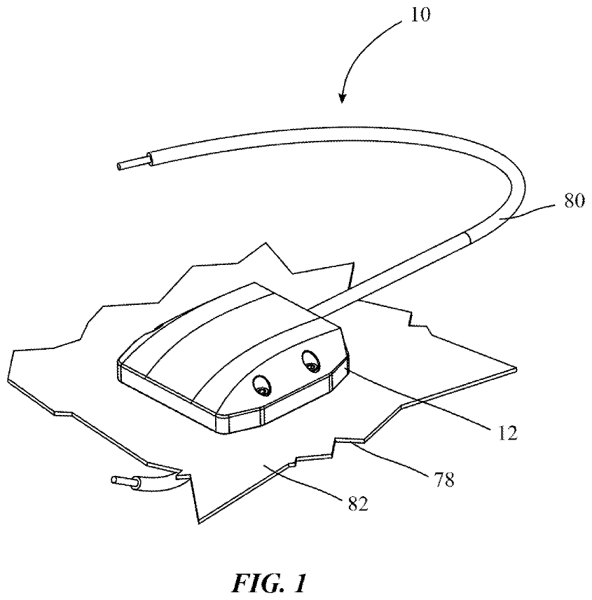

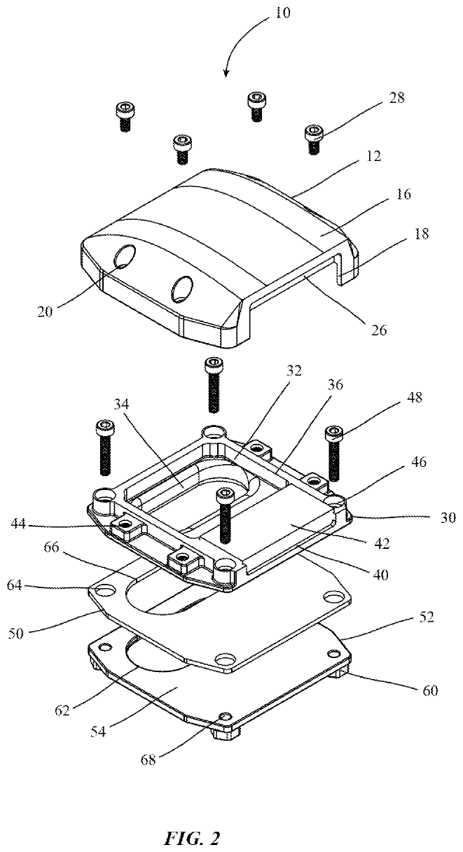

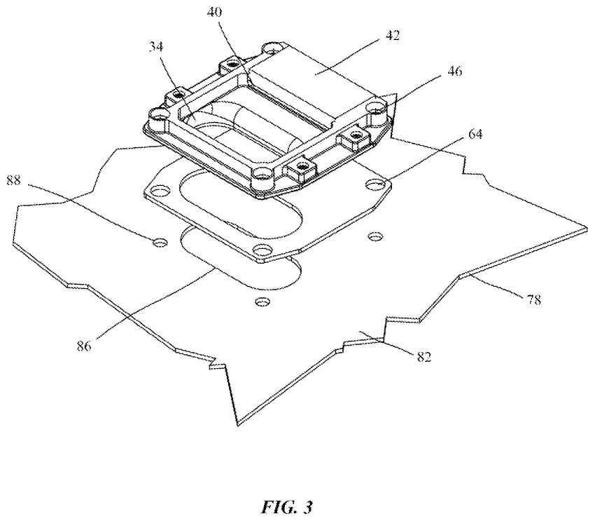

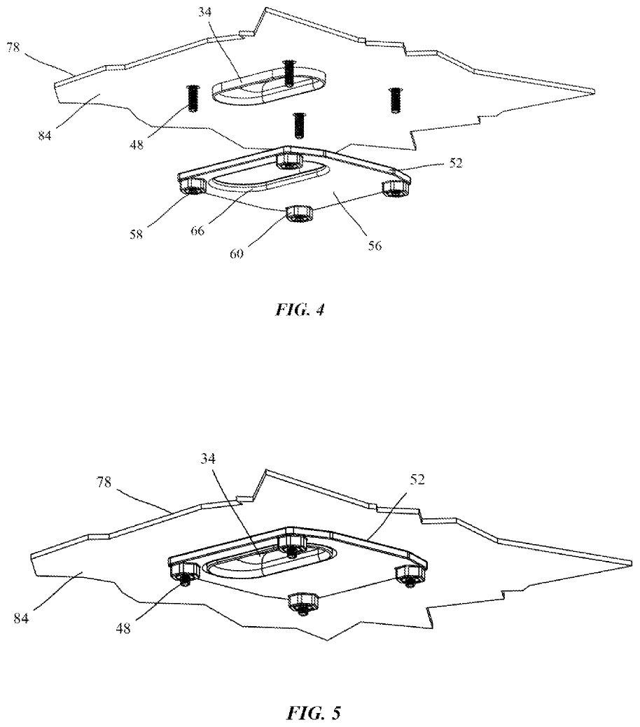

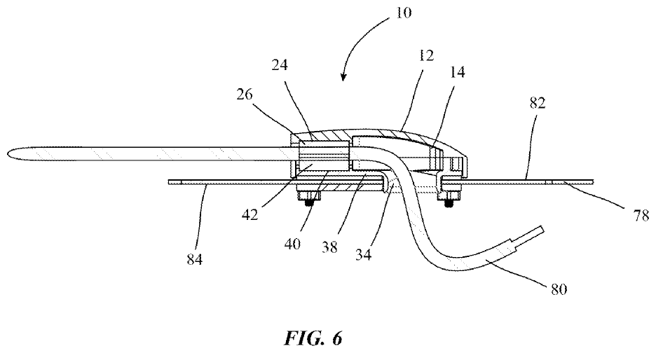

Referring initially to FIG. 1- 6, a cable pass through system shown generally at 10. A cable pass through system 10 which can pass one or more cables 80 through a roof 82 and a ceiling 84 of an enclosure 78. An enclosure can be such as, for example, a recreational vehicle, a truck, a sedan, a camping trailer, a fifth wheel, or the like. The cable pass through system 10 can comprise a cap 12 having an inner surface 14 and an outer surface 16 having a thickness creating walls that can create a shell that can cover and attach to a base 30 with one or more fasteners 22. The cap 12 can have an upper recess 24 on its inner surface 14 configured to accept an upper seal 26 wherein the upper seal can be attached to the recess by press fit, adhesive, sealant, fasteners, or the like. The upper recess 24 can be sized to match the shape and thickness of the upper seal 26. The cap 12 can be any suitable shape and size to meet the users desired needs and application, and in the preferred embodiment the cap can be aerodynamic with the front portion lower than the aft portion and can be shaped as if the elements were to penetrate one or more fasteners 28 that hold the cap onto the base 30 the elements would drain down and away from the assembly instead of through the assembly's seals and gasket 26, 42, 50 and past the upper seal 26 and the lower seal 40 barrier. The cap 12 can be manufactured from plastics such as Polyethylene Terephthalate, High-Density Polyethylene, Polyvinyl Chloride, polypropylene, Acrylonitrile Butadiene Styrene, HP Nylon PA12, resins or metals such as, stainless, aluminum, titanium, carbon steel, or the like.

The cap 12 can further comprise a slot 18 in its aft portion of the body, or in some embodiments the front side, left side, or right side wherein the slot can allow for the cable 80 to easily pass into the cap and then into the enclosure 78. The cap 12 can form a shell wherein the cap can extend over and around the base 30 and a gasket 46 and the cap can have substantially enough space to allow for one or more cables 80 to pass through the cap into the enclosure 78. The cap 12 can protect the inside of the enclosure 78 and keep the elements out of where the cables 80 are being routed into. The cables 80 can be electrical wires, cables, tubing, or the like that can be connected to Antennas, GPS unit, AC units, lights, horns, or the like. The cap 12 can act as a barrier and can seal the cable pass through system 10 from the outside elements as the cables 80 pass from the outside of the enclosure 78 to the inside of the enclosure.

The base 30 can comprise a base top 36 and a base bottom 38 wherein the base top can have a lower recess 40 wherein the lower recess can be sized and shaped to accept a lower seal 42. The upper seal 26 and the lower seal 42 attached to the base 30 and the cap 12 can form a seal around the cable 80. The upper seal 26 and the lower seal 42 can be manufactured from polyurethane, foam, neoprene, rubber, plastic, or any other type of material that can form around a cable or a wire and is waterproof In certain embodiments, the upper seal 26 and lower seal 42 can be integrated in the cap 12 and the base 30. The base 30 can further comprise a base slot 32 and a roof slot 34 wherein the base slot can transition into the roof slot to allow for the cables 80 to easily bend into the enclosure 78. The roof slot 34 can in the shape of such as, for example, a geometric stadium, a circle, a rectangle, a hexagon, or the like. The enclosure 78 can have a thru hole 86 cut thru the roof 82 and the ceiling 84 of the enclosure. The roof slot 24 can be substantially the same shape as a thru hole cut 86 into the enclosure 78. The roof slot 24 can protect the cables 80 from the sharp edges that is left in the enclosure when the holes in the enclosure are cut. The base 30 can be manufactured from plastics such as Polyethylene Terephthalate, High-Density Polyethylene, Polyvinyl Chloride, polypropylene, Acrylonitrile Butadiene Styrene, HP Nylon PA12, resins or metals such as, stainless, aluminum, titanium, carbon steel, or the like.

The base bottom 28 can further comprise one or more nut locks 44 substantially near the edges of the base wherein the nut locks can be, for example, pressed nuts, heated nuts, inserts, mold-in inserts, tapped/machined metal, or plastic threads within the base. The base 40 can further comprise at least one fastener thru holes 46 wherein the thru holes can capture the head of the one or more base fasteners 48 and allow the base fastener 48 to tighten the base onto the roof 82 with a gasket 50 between the base bottom 28 and the roof. The gasket 50 can be made of a weather resistant neoprene rubber, or in other embodiments it can be a sheet silicone, cork, or other soft rubber like materials. The gasket 50 can further comprise one or more gasket fastener holes 64, and a gasket slot 66 wherein the gasket slot allows for the roof slot 34 to extend from the base through the gasket, enclosure 78 and backing plate 52. The gasket fastener holes allow for the base fasteners to extend through the gasket, enclosure 78 and connect to the backing plate nuts 58. The gasket 50 can seal the base 30 to the enclosure 78 keeping the elements such as water, dust, and the like from penetrating the cable pass through system 10 and the enclosure. In certain embodiments the use of a silicone sealant in place of the gasket 50 can be used.

The base 28 can further comprise on its base bottom 38 one or more boss 60 features extending from the bottom and located at the one or more base fastener holes 46. In certain embodiments the boss 60 can be located at any location on the bottom of the base 30, or it can be omitted. The boss 60 can act as an anti-crush feature for the gasket, so that the gasket does not get smashed completely when tightening down and keeps it structural properties for keeping the elements out of the enclosure 78 and keep it from premature failure due to improper installation. Once the boss 60 comes into contact the enclosure 78 the gasket 50 cannot be compressed anymore.

The cable pass through system 10 can further comprise a backing plate 52 having a top side 54 and a bottom side 56 wherein the bottom side can have one or more backing plate nuts 58 capture substantially near the corners of the backing plate. The enclosure 78 can have one or more thru holes drilled or cut into it to allow the fasteners to easily pass through the enclosure. The backing plate 52 can be connected to the base 30 through the one or more base fasteners 48 wherein the fasteners can be passed through the enclosure's thru holes 86. The base fasteners 48 can be connected to the backing plate nuts 58 and can be tighten down the base 30 which can pull up on the backing plate 52 against the enclosure 78. The backing plate 52 can push up against the ceiling 84 and the base 30 can push against the gasket 50 which in turn can compresses against the roof 82, capturing the gasket and securing the base, gasket, and backing plate on the enclosure. The backing plate 52 can be manufactured from plastics such as Polyethylene Terephthalate, High-Density Polyethylene, Polyvinyl Chloride, polypropylene, Acrylonitrile Butadiene Styrene, HP Nylon PA12, resins or metals such as, stainless, aluminum, titanium, carbon steel, or the like.

Installing the cable pass through system 10 requires holes 88, 86 to be cut into the enclosure 78 wherein the enclosure can lose a small portion of rigidity. The backing plate 52 can add a rigid base to which the base 30 can be mounted to. This backing plate 52 can help to evenly distribute the mounting pressure of the cable pass through system 10 evenly and securely. The backing plate 52 can use metal inserts in the base 30 to prevent stripping of threads when installing the cable pass through system 10 and it can ensure that tight even pressure can be applied to the barrier material. The roof slot 24 can extend from the base bottom 38 through the holes cut in the enclosure and mate up with the bottom 56 of the backing plate 52. In certain embodiments the roof slot 24 can snap into the backing plate creating another seal between the base and the backing plate. In other embodiments the roof slot 34 can be omitted or it can be connected to the backing plate 52 and snap into the base 30, or it can be snap into both the backing plate and the base.

In closing, it is to be understood that although aspects of the present specification are highlighted by referring to specific embodiments, one skilled in the art will readily appreciate that these disclosed embodiments are only illustrative of the principles of the subject matter disclosed herein. Therefore, it should be understood that the disclosed subject matter is in no way limited to a particular methodology, protocol, and/or reagent, etc., described herein. As such, various modifications or changes to or alternative configurations of the disclosed subject matter can be made in accordance with the teachings herein without departing from the spirit of the present specification. Lastly, the terminology used herein is for the purpose of describing particular embodiments only and is not intended to limit the scope of the present disclosure, which is defined solely by the claims. Accordingly, embodiments of the present disclosure are not limited to those precisely as shown and described.

Certain embodiments are described herein, including the best mode known to the inventors for carrying out the methods and devices described herein. Of course, variations on these described embodiments will become apparent to those of ordinary skill in the art upon reading the foregoing description. Accordingly, this disclosure includes all modifications and equivalents of the subject matter recited in the claims appended hereto as permitted by applicable law. Moreover, any combination of the above-described embodiments in all possible variations thereof is encompassed by the disclosure unless otherwise indicated herein or otherwise clearly contradicted by context.

I claim:

1. A cable pass through system for running one or more cables into an enclosed space through an enclosure, the system comprising:
a shell comprising a cap and a base, wherein the shell has an exterior and an interior and wherein the cap may be coupled to the base with one or more fasteners;
a cutout in the shell through which one or more cables may pass;
at least one deformable seal about the periphery of the cutout positioned so that when the cap is coupled to the base with the one or more cables situated in the cutout the seal is deformed about the one or more cable to at least partially seal the interior of the shell from the exterior of the shell;
a gasket situated between the base and the enclosure; and
a backing plate removably coupled to the base such that the ceiling may be situated between the backing plate and the base when the backing plate is coupled to the base.

2. The cable pass through system according to claim 1, wherein the at least one seal is situated in a recess formed in the shell.

3. The cable pass through system according to claim 1, wherein the shell comprises a slot allowing the one or more cables to pass through the shell, and wherein the seal comprises a first seal coupled to the cap and a second seal coupled to the base.

4. The cable pass through system according to claim 1, wherein the base further comprises a base slot and a roof slot wherein the ceiling slot transitions from the base slot with a radius.

5. The cable pass through system according to claim 4, wherein the enclosure comprises a slot having substantially the same shape as the roof slot and one or more thru holes for one or more base fasteners.

6. The cable pass through system according to claim 1, wherein the base further comprises one or more nut locks and one or more fastener holes wherein one or more nuts can be inserted into and locked into position with the nut locks.

7. The cable pass through system according to claim 1, wherein the gasket forms a watertight seal between the base and the enclosure.

8. The cable pass through system according to claim 1, wherein backing plate comprises one or more nut slots wherein one or more fasteners fasten the base to the backing plate with the gasket captured between the backing plate and the enclosure wherein the backing place compresses against the enclosure.

9. The cable pass through system according to claim 1, wherein the cap fastens to the base by one or more fasteners.

10. The cable pass through system according to claim 1, wherein at least one of the cap, base and backing plate are manufactured from plastic or metal.

11. The cable pass through system according to claim 1, wherein the base further comprises one or more bosses wherein the bosses substantially contacts the enclosure, stopping the gasket from over compressing.
